(19) United States
(12) Patent Application Publication
(10) Pub. No.: US 2014/0241255 A1
(43) Pub. Date: Aug. 28, 2014

(54) QUICK CALL SETUP FOR STATIONARY MACHINE-TO-MACHINE DEVICES AND METHODS

(71) Applicant: QUALCOMM INCORPORATED, SAN DIEGO, CA (US)

(72) Inventors: BHASKARA V. BATCHU, HYDERABAD (IN); SHARAD SHAHI, HYDERABAD (IN); ANAND RAJURKAR, HYDERABAD (IN)

(73) Assignee: QUALCOMM INCORPORATED, SAN DIEGO, CA (US)

(21) Appl. No.: 13/777,192

(22) Filed: Feb. 26, 2013

(51) Int. Cl. H04W 28/24

(52) U.S. Cl. CPC H04W 28/24
USPC 370/329

(57) ABSTRACT

Aspects of the present disclosure relate to methods and apparatuses for wireless communications with improved call setup for stationary machine-to-machine devices. One aspect of the disclosure provides a method of initiating a call in a wireless communication network. The method includes: setting up an initial call with a base station; storing a set of negotiated service parameters in a memory; ending the initial call; and establishing a subsequent call with the base station based on the set of negotiated service parameters. Other aspects, embodiments, and features are also claimed and described.

### TECHNICAL FIELD

The technology discussed below relates generally to wireless communication systems, and more particularly, to call setup for stationary machine-to-machine devices and methods. Inventive features enable efficient operations that can aid connection attempts and efficient use of power resources.

### BACKGROUND

Wireless communications systems are widely deployed to provide various types of communication content such as voice, video, packet data, messaging, broadcast, and so on. These systems may be accessed by various types of access terminals adapted to facilitate wireless communications, where multiple access terminals share the available system resources (e.g., time, frequency, and power). Examples of such wireless communications systems include code-division multiple access (CDMA) systems (e.g., CDMA2000), time-division multiple access (TDMA) systems, frequency-division multiple access (FDMA) systems and orthogonal frequency-division multiple access (OFDMA) systems.

Machine-to-machine (M2M) devices, also known as machine-type communication (MTC) devices, are wireless access terminals that utilize the same communication network as mobile phones. M2M devices are automated and generally do not rely on user input. Some examples are devices that regularly report utility usage (smart meters), home or business alarm reporting, or sensors such as water level sensors, earthquake sensors, etc.

M2M devices periodically or intermittently wake up to send some form of report to a network without requiring human interaction. When an M2M device is deployed at a fixed location, it will generally communicate with the same cell unless the M2M device is relocated to a new location. Therefore, features which may assist in optimizing cell setup processes between fixed-location M2M devices and a serving cell, are beneficial.

### BRIEF SUMMARY OF SOME EMBODIMENTS

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure relate to methods and apparatuses for wireless communications with improved call setup for stationary machine-to-machine devices. One aspect of the disclosure provides a method of initiating a call in a wireless communication network. The method includes: setting up an initial call with a base station; storing a set of negotiated service parameters in a memory; ending the initial call; and establishing a subsequent call with the base station based on the set of negotiated service parameters.

Another aspect of the disclosure provides an apparatus for wireless communication. The apparatus includes: means for setting up an initial call with a base station; means for storing a set of negotiated service parameters in a memory; means for ending the initial call; and means for establishing a subsequent call with the base station based on the set of negotiated service parameters.

Another aspect of the disclosure provides a computer program product, including: a computer-readable storage medium including code for causing an access terminal to set up an initial call with a base station; store a set of negotiated service parameters in a memory; end the initial call; and establish a subsequent call with the base station based on the set of negotiated service parameters.

Another aspect of the disclosure provides an apparatus for wireless communication. The apparatus includes at least one processor, a communication interface coupled to the at least one processor, and a memory coupled to the at least one processor. The at least one processor is configured to: set up an initial call with a base station; store a set of negotiated service parameters in the memory; end the initial call; and establish a subsequent call with the base station based on the set of negotiated service parameters.

Another aspect of the disclosure provides a method of initiating a call in a wireless communication network. The method includes: setting up an initial call with an access terminal using a set of negotiated service parameters; ending the initial call; and establishing a subsequent call with the access terminal based on the set of negotiated service parameters received from the access terminal.

Another aspect of the disclosure provides an apparatus for wireless communication. The apparatus includes: means for setting up an initial call with an access terminal using a set of negotiated service parameters; means for ending the initial call; and means for establishing a subsequent call with the access terminal based on the set of negotiated service parameters received from the access terminal.

Another aspect of the disclosure provides a computer program product, including: a computer-readable storage medium including code for causing a base station to: set up an initial call with an access terminal using a set of negotiated service parameters; end the initial call; and establish a subsequent call with the access terminal based on the set of negotiated service parameters received from the access terminal.

Another aspect of the disclosure provides an apparatus for wireless communication. The apparatus includes at least one processor, a communication interface coupled to the at least one processor, and a memory coupled to the at least one processor. The at least one processor is configured to: set up an initial call with an access terminal using a set of negotiated service parameters; end the initial call; and establish a subsequent call with the access terminal based on the set of negotiated service parameters received from the access terminal.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a network environment in which one or more aspects of the present disclosure may find application.

FIG. 2 is a block diagram illustrating an example of a protocol stack architecture which may be implemented by an access terminal.

FIG. 3 is a call flow diagram illustrating some signaling of a call establishment process between a machine-to-machine device and a base station in the related art.

FIG. 4 is a call flow diagram illustrating a call establishment process between a machine-to-machine device and a base station in accordance with an aspect of the present disclosure.

FIG. 5 is a conceptual diagram illustrating an example of a hardware implementation for an apparatus employing a processing system in accordance with an aspect of the present disclosure.

FIG. 6 is a flow chart illustrating a method of initiating a call at a mobile device in a wireless communication network in accordance with an aspect of the disclosure.

FIG. 7 is a flow chart illustrating a method of initiating a call at a base station in a wireless communication network in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The various concepts presented throughout this disclosure may be implemented across a broad variety of wireless communication systems, network architectures, and communication standards. Certain aspects of the discussions are described below for CDMA and 3rd Generation Partnership Project 2 (3GPP2) CDMA2000 (C2K) protocols and systems, and related terminology may be found in much of the following description. However, those of ordinary skill in the art will recognize that one or more aspects of the present disclosure may be employed and included in one or more other wireless communication protocols and systems such as Universal Mobile Telecommunications System (UMTS), an Evolved Packet System (EPS), or any other suitable system for wireless cellular communication.

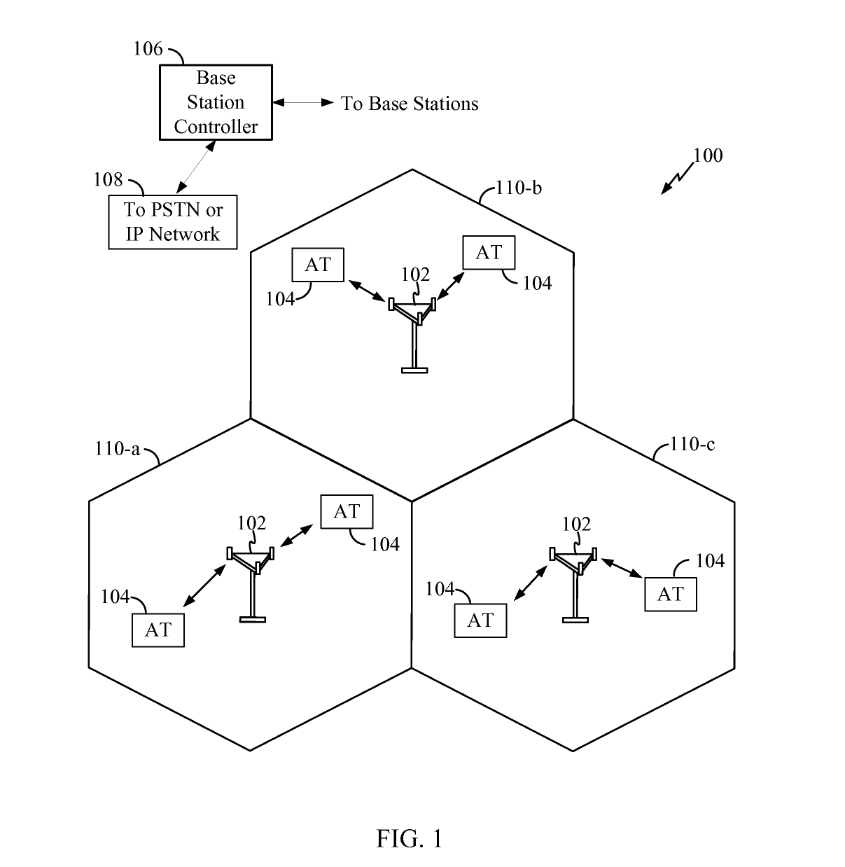

FIG. 1 is a block diagram illustrating an example of a C2K network environment in which one or more aspects of the present disclosure may find application. The wireless communication system 100 generally includes one or more base stations 102, one or more access terminals 104 (e.g., M2M devices), one or more base station controllers (BSC) 106, and a core network 108 providing access to a public switched telephone network (PSTN) (e.g., via a mobile switching center/visitor location register (MSC/VLR)) and/or to an IP network (e.g., via a packet data switching node (PDSN)).

The base stations 102 can wirelessly communicate with the access terminals 104 via a base station antenna. The base stations 102 may each be implemented generally as a device adapted to facilitate wireless connectivity (for one or more access terminals 104) to the wireless communications system 100. A base station 102 may also be referred to by those skilled in the art as an access point, a base transceiver station (BTS), a radio base station, a radio transceiver, a transceiver function, a basic service set (BSS), an extended service set (ESS), a Node B, a femto cell, a pico cell, and/or some other suitable terminology.

The base stations 102 are configured to communicate with the access terminals 104 under the control of the base station controller 106 via one or more carriers. Each of the base stations 102 can provide communication coverage for a respective geographic area. The coverage area 110 for each base station 102 here is identified as cells 110-a, 110-b, or 110-c. The coverage area 110 for a base station 102 may be divided into sectors (not shown, but making up only a portion of the coverage area). In a coverage area 110 that is divided into sectors, the multiple sectors within a coverage area 110 can be formed by groups of antennas with each antenna responsible for communication with one or more access terminals 104 in a portion or sector of the cell.

One or more access terminals 104 may be dispersed throughout the coverage areas 110, and may wirelessly communicate with one or more sectors associated with each respective base station 102. An access terminal 104 may generally include one or more devices that communicate with one or more other devices through wireless signals. Such access terminals 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. The access terminals 104 may include mobile terminals and/or at least substantially fixed terminals. Examples of access terminals 104 include mobile phones, pagers, wireless modems, personal digital assistants, personal information managers (PIMs), personal media players, palmtop computers, laptop computers, tablet computers, televisions, appliances, e-readers, digital video recorders (DVRs), machine-to-machine (M2M) devices, and/or other communication/computing devices which communicate, at least partially, through a wireless or cellular network.

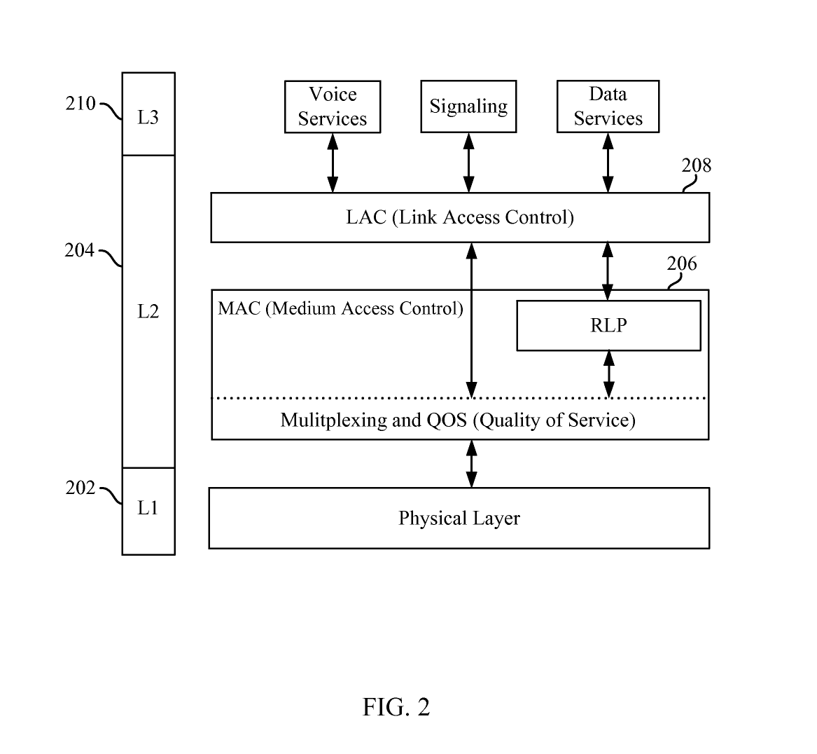

The access terminal 104 may be adapted to employ a protocol stack architecture for communicating data between the access terminal 104 and one or more network nodes of the wireless communication system 100 (e.g., the base station 102). A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base. FIG. 2 is a block diagram illustrating an example of a protocol stack architecture which may be implemented by an access terminal 104. Referring to FIGS. 1 and 2, the protocol stack architecture for the access terminal 104 is shown to generally include three layers: Layer 1 (L1), Layer 2 (L2), and Layer 3 (L3).

Layer 1 202 is the lowest layer and implements various physical layer signal processing functions. Layer 1 202 is also referred to herein as the physical layer 202. This physical layer 202 provides for the transmission and reception of radio signals between the access terminal 104 and a base station 102 via an air interface.

The data link layer, called layer 2 (or “the L2 layer”) 204 is above the physical layer 202 and is responsible for delivery of signaling messages generated by Layer 3. The L2 layer 204 makes use of the services provided by the physical layer 202. The L2 layer 204 may include two sublayers: the Medium Access Control (MAC) sublayer 206, and the Link Access Control (LAC) sublayer 208.

The MAC sublayer 206 is the lower sublayer of the L2 layer 204. The MAC sublayer 206 implements the medium access protocol and is responsible for transport of higher layers' protocol data units using the services provided by the physical layer 202. The MAC sublayer 206 may manage the access of data from the higher layers to the shared air interface.

The LAC sublayer 208 is the upper sublayer of the L2 layer 204. The LAC sublayer 208 implements a data link protocol that provides for the correct transport and delivery of signaling messages generated at the layer 3. The LAC sublayer makes use of the services provided by the lower layers (e.g., layer 1 and the MAC sublayer).

Layer 3 210, which may also be referred to as the upper layer or the L3 layer, originates and terminates signaling messages according to the semantics and timing of the communication protocol between a base station 102 and an access terminal 104. The L3 layer 210 makes use of the services provided by the L2 layer 204. Information (both data and voice) messages are also passed through the L3 layer 210.

As an access terminal 104 operates within the system 100, the access terminal 104 may operate in any of various states of operation, including an idle state and a system access state. In the system access state, the access terminal 104 may actively exchange data (e.g., voice or data calls or sessions) with one or more base stations (e.g., base stations 102 in FIG. 1). In the idle state, the access terminal 104 may monitor control channels, including but not limited to one or more of a common control channel (F-CCCH) and a broadcast control channel (F-BCCH) for carrying signaling data, a paging channel (F-PCH) for carrying system and overhead data such as paging messages, and/or a quick paging channel (F-QPCH) for letting the access terminal 104 know whether or not to receive the F-CCCH or the F-PCH in the next slot. The paging messages carried on the F-PCH (referred to herein as the PCH for brevity) may include messages that alert the access terminal 104 to the occurrence of an incoming voice or data call and control/overhead messages that carry system information and other information for the access terminal 104.

As described above, in some examples the access terminal 104 may be implemented as a machine-to-machine (M2M) or machine-type communication (MTC) device. Such M2M devices utilize the same communication network as mobile phones, but are automated and generally do not rely on user input. Some examples are devices that regularly report utility usage (smart meters), home or business alarm reporting, or sensors such as water level sensors, earthquake sensors, etc. In any case, an M2M device periodically or intermittently wakes up to send some form of report to a network without requiring human interaction.

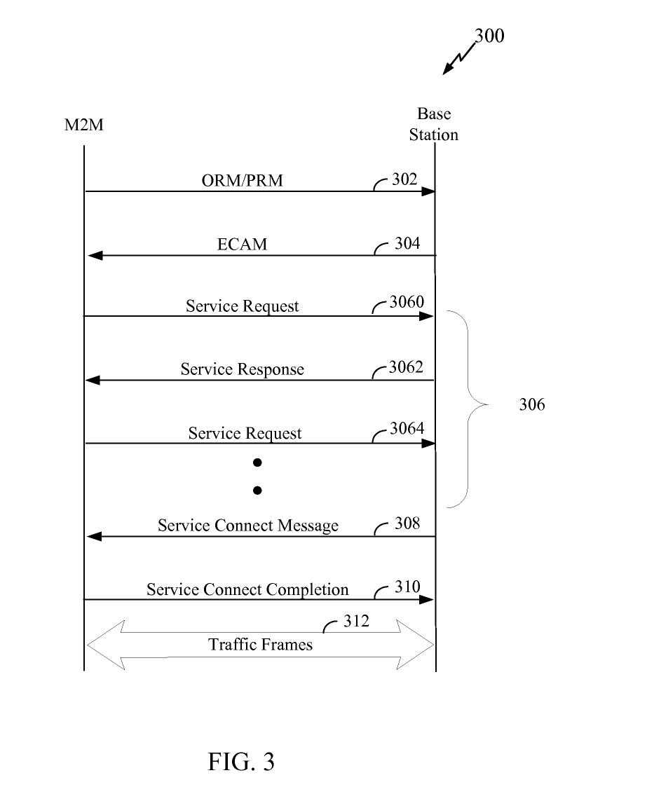

FIG. 3 is a call flow diagram illustrating some signaling of a call establishment process 300 between an M2M device (e.g., an access terminal 104) and a base station (e.g., a base station 102) in the related art. To make a call, the M2M device needs to initialize a traffic channel. During the traffic channel initialization procedure, the M2M device negotiates with the base station, and finally, both the M2M device and the base station mutually agree to a set of service negotiation parameters. Referring to FIG. 3, to establish a call, the M2M device sends (302) an Origination Message (ORM) or a Page Response Message (PRM) to the base station. The ORM is sent when the M2M device initiates the call. The PRM is sent when the base station initiates the call. The ORM/PRM can be sent on a Reverse Access Channel (R-ACH) or Reverse Enhanced Access Channel (R-EACH). The base station may send (304) a Channel Assignment Message or an Extended Channel Assignment Message (ECAM) to the M2M device on a Paging Channel (F-PCH) or Forward Common Control Channel (F-CCCH). By way of example, FIG. 3 illustrates an ECAM being sent by the base station. Then, the M2M device and base station go through service negotiation 306, which typically includes multiple service requests and responses, until the base station agrees to the parameters proposed by the M2M device.

Some examples of service parameters include a forward multiplex option, a reverse multiplex option, forward channel radio configurations, reverse radio configurations, radio link protocol related parameters, and quality of service related parameters, etc. For more details about these parameters for EV-DO, see 3GPP2 C.S0005 Rev E document. During service negotiation 306, the M2M device may send one or more service request messages (e.g., 3060, 3064) to the base station, and the base station may reply with one or more service response messages (e.g., 3062).

Once the base station agrees to the service parameters proposed by the M2M device, the base station sends a Service Connect Message 308 to the M2M device, and the M2M device returns a Service Connect Completion 310. The service parameters are finalized when the base station transmits the Service Connect Message 308 on, for example, the Forward Fundamental Channel (F-FCH). The M2M device responds with a Service Connect Completion 310 on, for example, the Reversal Fundamental Channel (R-FCH), after which the M2M device and the base station may begin to actively exchange traffic frames 312 (e.g., user voice data or packet data over an air link).

For M2M devices that remain stationary throughout most of their operational lifetime, it is generally expected that the M2M device will always latch onto the same, previously visited cell or base station. Because the stationary M2M device and the base station preferences for service negotiation parameters generally remain the same for all time, the service negotiation of these stationary M2M devices becomes unwanted overhead signaling, and it is not really required or desirable. The service negotiation procedure (e.g., 306) can potentially result in substantial signaling between the M2M device and the base station, and in the case of a stationary M2M device, can be unnecessary since the negotiation between the M2M device at the same location and the same base station would almost always result in the same negotiated parameters. Thus, to save the battery at the M2M device and to reduce call setup time, it would be beneficial to forgo or simplify the service negotiation procedure.

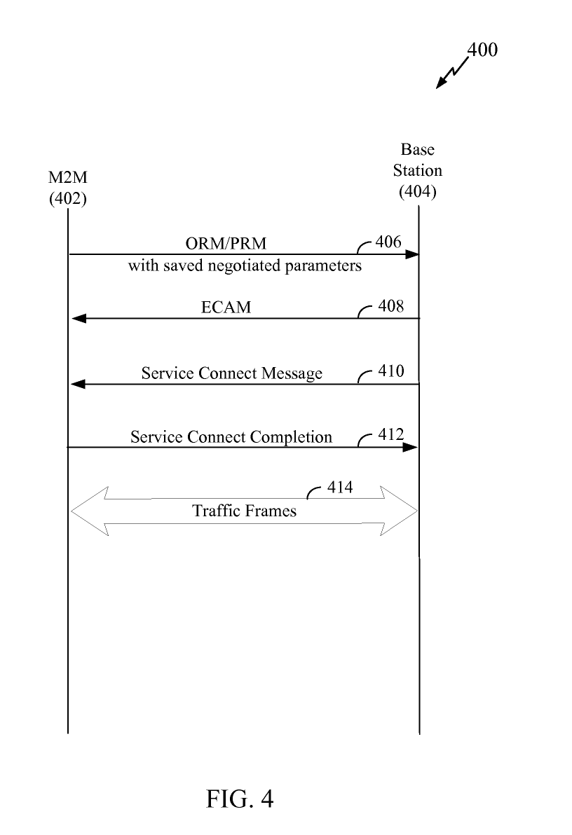

FIG. 4 is a call flow diagram illustrating a call establishment process 400 between an M2M device 402 (e.g., an access terminal 104) and a base station 404 (e.g., a base station 102) in accordance with an aspect of the present disclosure. In the illustrated example, the call establishment process 400 between a stationary M2M device 402 and a base station 404 may be optimized by skipping the service negotiation procedure (described above and illustrated at FIG. 3, 306) after a first call. For a newly installed stationary M2M device 402, the very first call to the base station 404 may utilize a call establishment process similar to the process 300. That is, during the first call, the M2M device 402 and base station 404 may go through service negotiation until the base station 404 agrees to the parameters proposed by the M2M device 402. During service negotiation, the M2M device 402 may send one or more service request messages to the base station 404, and the base station 404 may reply with one or more service response messages. Once the base station 404 agrees to the service parameters proposed by the M2M device 402, the M2M device 402 and the base station 404 may begin to actively exchange traffic frames (e.g., user voice data or packet data over the air link).

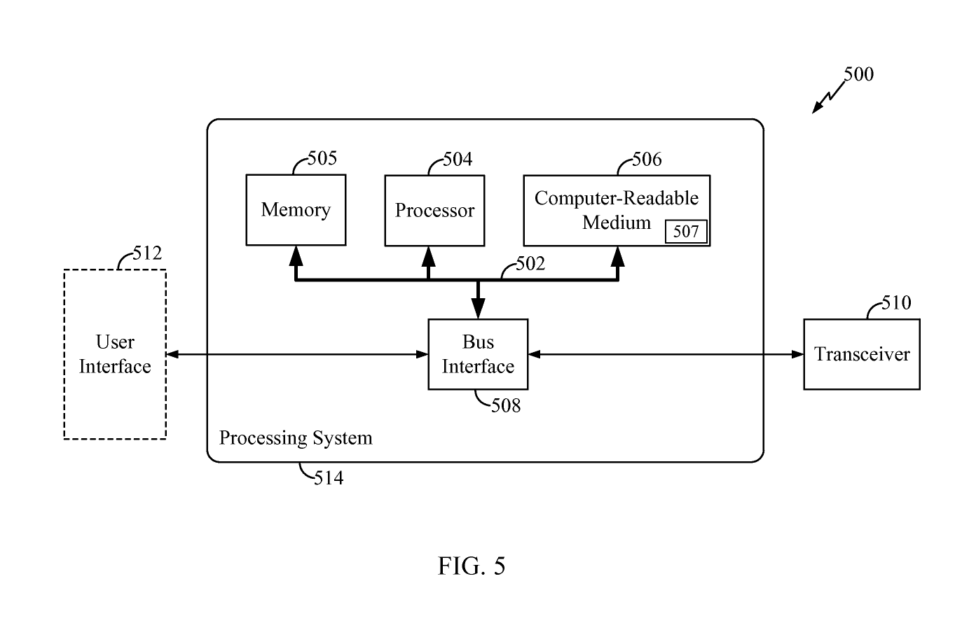

After the first call service negotiation with the current base station 404, in an aspect of the present disclosure, the M2M device 402 may save all the negotiated parameters in its memory (e.g., the memory 505, with reference to FIG. 5). The negotiated parameters include, but are not limited to, a forward multiplex option, a reverse multiplex option, forward channel radio configurations, reverse radio configurations, radio link protocol related parameters, and quality of service related parameters, etc.

Subsequently, still referring to FIG. 4, when originating a call or responding to a page from the same base station 404, the M2M device 402 may reuse the already saved information and signal this information as an initial configuration proposal in an ORM/PRM message 406 that is configured to include the saved negotiated parameters. The base station 404 may respond with a channel assignment message (e.g., an ECAM) 408. Since the base station 404 already supported the previously negotiated parameters, the base station 404 can skip the negotiation procedure and directly send the Service Connect Message 410. The M2M device 402 may respond by sending the Service Connect Completion 412. With this approach, the Service Request (e.g., FIG. 3, 3060 and 3064) and Service Response messages (e.g., FIG. 3, 3062) between the M2M device 402 and the base station 404 may be skipped after the first call. Accordingly, the call can be set up very quickly by directly accepting the M2M proposed configuration and directly sending the Service Connect Message 410. In one example, this design can be implemented with suitable software in Layer 3 (e.g., L3 210 in FIG. 2) at the M2M device 402 and at the base station 404 (or another node in the network that controls the base station, such as a base station controller BSC or radio network controller RNC).

FIG. 5 is a conceptual diagram illustrating an example of a hardware implementation for an apparatus 500 employing a processing system 514. For example, the access terminal 104 and the base station 102 may be implemented using the apparatus 500. In accordance with various aspects of the disclosure, an element, or any portion of an element, or any combination of elements may be implemented with a processing system 514 that includes one or more processors 504. Examples of processors 504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 514 may be implemented with a bus architecture, represented generally by the bus 502. The bus 502 may include any number of interconnecting buses and bridges depending on the specific application of the processing system 514 and the overall design constraints. The bus 502 links together various circuits including one or more processors (represented generally by the processor 504), a memory 505, and computer-readable media (represented generally by the computer-readable medium 506). The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The transceiver 510 provides a means for communicating with various other apparatus over a transmission medium. Depending upon the nature of the apparatus, a user interface 512 (e.g., keypad, display, speaker, microphone, joystick) may also be provided.

The processor 504 is responsible for managing the bus 502 and general processing, including the execution of software 507 stored on the computer-readable medium 506. The software, when executed by the processor 504, causes the processing system 514 to perform the various functions described infra for any particular apparatus. For example, the processing system may be utilized to perform the call establishment process described in FIG. 4. The computer-readable medium 506 may also be used for storing data that is manipulated by the processor 504 when executing software. For example, the computer-readable medium 506 may be used to store negotiated parameters 507 (e.g., negotiated parameters discussed in reference to FIG. 4).

One or more processors 504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 506. The computer-readable medium 506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium. The computer-readable medium 506 may reside in the processing system 514, external to the processing system 514, or distributed across multiple entities including the processing system 514. The computer-readable medium 506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one configuration, the apparatus 500 for wireless communication includes means for setting up an initial call with a base station, means for storing a set of negotiated service parameters in a memory; means for ending the initial call; and means for establishing a subsequent call with the base station based on the set of negotiated service parameters. In another configuration, the apparatus 500 for wireless communication includes means for setting up an initial call with a mobile device (e.g., an M2M device), means for ending the initial call, and means for establishing a subsequent call with the mobile device based on a set of negotiated service parameters stored at the mobile device. In one aspect, the aforementioned means may be the processor(s) 504 in which the invention resides from FIG. 5 configured to perform the functions recited by the aforementioned means. In another aspect, the aforementioned means may be a module or any apparatus configured to perform the functions recited by the aforementioned means.

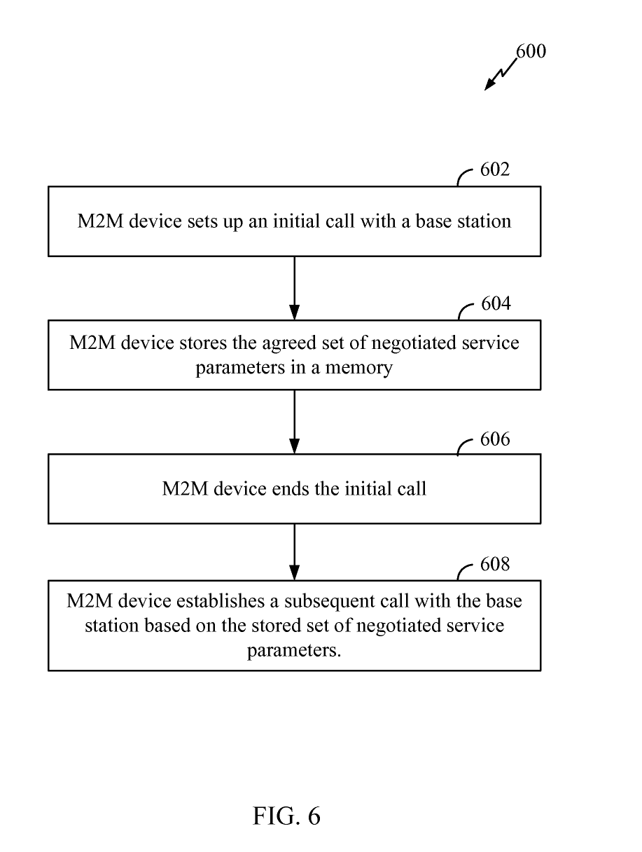

FIG. 6 is a flow chart illustrating a method of initiating a call at an M2M device (e.g., an M2M device 402) with a base station (e.g., a base station 404) in a wireless communication network in accordance with an aspect of the disclosure. At step 602, an M2M device 402 sets up an initial call with a base station. For example, the M2M device may set up the initial call with the base station based on the process 300 in FIG. 3. During a first call service negotiation (e.g., 306 in FIG. 3), the M2M device and the base station agree on a set of negotiated service parameters. At step 604, the M2M device stores the agreed set of negotiated service parameters in a memory (e.g., the memory 505 or the computer-readable medium 506 in FIG. 5). At step 606, the M2M device ends the initial call. Afterward, in 608, the M2M device establishes a subsequent call with the base station based on the stored set of negotiated service parameters. For example, the M2M device may establish the subsequent call based on the process 400 in which no service negotiation is performed after the first call. Accordingly, the call can be quickly set up between the M2M device and the base station.

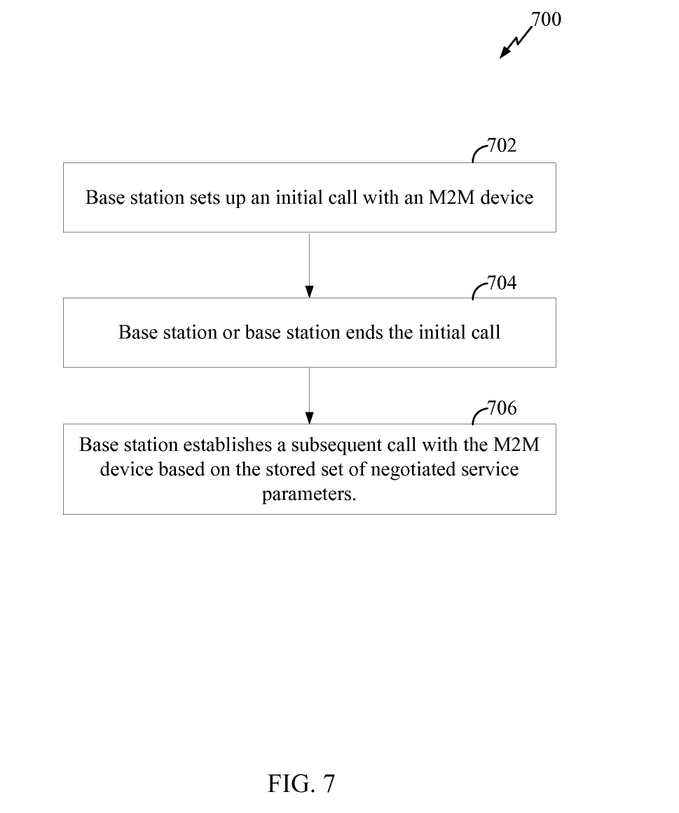

FIG. 7 is a flow chart illustrating a method 700 of initiating a call at a base station (e.g., a base station 404) with an M2M device (e.g., an M2M device 402) in a wireless communication network in accordance with an aspect of the disclosure. At step 702, the base station 404 sets up an initial call with the M2M device 402. For example, the base station 404 may set up the initial call with the M2M device 402 based on the process 300 in FIG. 3. During first call service negotiation (e.g., 306 in FIG. 3), the base station 404 and the M2M device 402 agree on a set of negotiated service parameters. These parameters may be stored at the M2M device 402. In 704, the M2M device 402 or the base station 404 ends the initial call. Afterward, in 706, the base station 404 establishes a subsequent call with the M2M device 402 based on the set of negotiated service parameters stored at the M2M device 402. For example, the base station 404 may establish the subsequent call based on the process 400, in which no service negotiation is performed after the first call. Accordingly, the call can be quickly set up between the M2M device 402 and the base station 404.

Several aspects of a telecommunications system have been presented with reference to a CDMA2000 system. As those skilled in the art will readily appreciate, various aspects described throughout this disclosure may be extended to other telecommunication systems, network architectures and communication standards.

By way of example, various aspects may be extended to UMTS systems such as W-CDMA, TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of initiating a call in a wireless communication network, comprising:
setting up an initial call with a base station;
storing a set of negotiated service parameters in a memory;
ending the initial call; and
establishing a subsequent call with the base station based on the set of negotiated service parameters.

2. The method of claim 1, wherein establishing the subsequent call comprises:
transmitting a call origination message or a page response message, comprising information corresponding to the set of negotiated service parameters.

3. The method of claim 2, wherein establishing the subsequent call further comprises:
receiving a service connect message from the base station without performing service negotiation with the base station during the subsequent call; and
sending a service connect completion message to the base station.

4. The method of claim 1, wherein establishing the subsequent call comprises:
receiving a call confirmation message from the base station indicating acceptance of the set of negotiated service parameters for the subsequent call with the base station.

5. The method of claim 1, wherein the set of negotiated service parameters comprise at least one of: a forward multiplex option, a reverse multiplex option, a forward channel radio configuration, a reverse radio configuration, radio link protocol related parameters, or quality of service related parameters.

6. The method of claim 1, wherein the setting up comprises setting up the initial call at a fixed-location machine-to-machine device.

7. An apparatus for wireless communication, comprising:
means for setting up an initial call with a base station;
means for storing a set of negotiated service parameters in a memory;
means for ending the initial call; and
means for establishing a subsequent call with the base station based on the set of negotiated service parameters.

8. The apparatus of claim 7, wherein the means for establishing the subsequent call comprises: means for transmitting a call origination message or a page response message, comprising information corresponding to the set of negotiated service parameters.

9. The apparatus of claim 8, wherein the means for establishing the subsequent call further comprises:
means for receiving a service connect message from the base station without performing service negotiation with the base station; and
means for sending a service connect completion message to the base station.

10. The apparatus of claim 7, wherein the means for establishing the subsequent call comprises: means for receiving a call confirmation message from the base station indicating acceptance of the set of negotiated service parameters for the subsequent call with the base station.

11. The apparatus of claim 7, wherein the set of negotiated service parameters comprise at least one of forward multiplex option, reverse multiplex option, forward channel radio configurations, reverse radio configurations, radio link protocol related parameters, or quality of service related parameters.

12. The apparatus of claim 7, wherein the apparatus is a fixed-location machine-to-machine device.

13. A computer program product, comprising:
a computer-readable storage medium comprising code for causing an access terminal to set up an initial call with a base station;
store a set of negotiated service parameters in a memory;
end the initial call; and
establish a subsequent call with the base station based on the set of negotiated service parameters.

14. The computer program product of claim 13, wherein for establishing the subsequent call, the storage medium further comprises code for causing the access terminal to: transmit a call origination message or a page response message, comprising information corresponding to the set of negotiated service parameters.

15. The computer program product of claim 14, wherein for establishing the subsequent call, the storage medium further comprises code for causing the access terminal to:
receive a service connect message from the base station without performing service negotiation with the base station; and
send a service connect completion message to the base station.

16. The computer program product of claim 13, wherein establishing the subsequent call comprises: receiving a call confirmation message from the base station indicating acceptance of the set of negotiated service parameters for the subsequent call with the base station.

17. The computer program product of claim 13, wherein the set of negotiated service parameters comprise at least one of forward multiplex option, reverse multiplex option, forward channel radio configurations, reverse radio configurations, radio link protocol related parameters, or quality of service related parameters.

18. The computer program product of claim 13, wherein the access terminal is a fixed-location machine-to-machine device.

19. An apparatus for wireless communication, comprising:
at least one processor;
a communication interface coupled to the at least one processor; and
a memory coupled to the at least one processor,
wherein the at least one processor is configured to:
set up an initial call with a base station;
store a set of negotiated service parameters in the memory;
end the initial call; and
establish a subsequent call with the base station based on the set of negotiated service parameters.

20. The apparatus of claim 19, wherein for establishing the subsequent call, the at least one processor is configured to: transmit a call origination message or a page response message, comprising information corresponding to the set of negotiated service parameters.

21. The apparatus of claim 20, wherein for establishing the subsequent call, the at least one processor is configured to:
receive a service connect message from the base station without performing service negotiation with the base station; and
send a service connect completion message to the base station.

22. The apparatus of claim 19, wherein for establishing the subsequent call, the at least one processor is configured to: receive a call confirmation message from the base station indicating acceptance of the set of negotiated service parameters for the subsequent call with the base station.

23. The apparatus of claim 19, wherein the set of negotiated service parameters comprise at least one of forward multiplex option, reverse multiplex option, forward channel radio configurations, reverse radio configurations, radio link protocol related parameters, or quality of service related parameters.

24. The apparatus of claim 19, wherein the apparatus is a fixed-location machine-to-machine device.

25. A method of initiating a call in a wireless communication network, comprising:
setting up an initial call with an access terminal using a set of negotiated service parameters;
ending the initial call; and
establishing a subsequent call with the access terminal based on the set of negotiated service parameters received from the access terminal.

26. The method of claim 25, wherein establishing the subsequent call comprises:
receiving a call origination message or a page response message from the access terminal, comprising information corresponding to the set of negotiated service parameters.

27. The method of claim 26, wherein establishing the subsequent call further comprises:
sending a service connect message to the access terminal without performing service negotiation with the access terminal; and
receiving a service connect completion message from the access terminal.

28. The method of claim 25, wherein establishing the subsequent call comprises:
sending a call confirmation message to the access terminal indicating acceptance of the set of negotiated service parameters for the subsequent call with the access terminal.

29. The method of claim 25, wherein the set of negotiated service parameters comprise at least one of forward multiplex option, reverse multiplex option, forward channel radio configurations, reverse radio configurations, radio link protocol related parameters, or quality of service related parameters.

30. An apparatus for wireless communication, comprising:
means for setting up an initial call with an access terminal using a set of negotiated service parameters;
means for ending the initial call; and
means for establishing a subsequent call with the access terminal based on the set of negotiated service parameters received from the access terminal.

31. The apparatus of claim 30, wherein the means for establishing the subsequent call comprises:
means for receiving a call origination message or a page response message from the access terminal, comprising information corresponding to the set of negotiated service parameters.

32. The apparatus of claim 31, wherein the means for establishing the subsequent call further comprises:
means for sending a service connect message to the access terminal without performing service negotiation with the access terminal; and
means for receiving a service connect completion message from the access terminal.

33. The apparatus of claim 30, wherein the means for establishing the subsequent call comprises:
means for sending a call confirmation message to the access terminal indicating acceptance of the set of negotiated service parameters for the subsequent call with the access terminal.

34. The apparatus of claim 30, wherein the set of negotiated service parameters comprise at least one of forward multiplex option, reverse multiplex option, forward channel radio configurations, reverse radio configurations, radio link protocol related parameters, or quality of service related parameters.

35. A computer program product, comprising:
a computer-readable storage medium comprising code for causing a base station to:
set up an initial call with an access terminal using a set of negotiated service parameters;
end the initial call; and
establish a subsequent call with the access terminal based on the set of negotiated service parameters received from the access terminal.

36. The computer program product of claim 35, wherein for establishing the subsequent call, the storage medium comprises code for causing the base station to:
receive a call origination message or a page response message from the access terminal, comprising information corresponding to the set of negotiated service parameters.

37. The computer program product of claim 36, wherein for establishing the subsequent call, the storage medium further comprises code for causing the base station to:
send a service connect message to the access terminal without performing service negotiation with the access terminal; and
receive a service connect completion message from the access terminal.

38. The computer program product of claim 35, wherein for establishing the subsequent call, the storage medium further comprises code for causing the base station to:
send a call confirmation message to the access terminal indicating acceptance of the set of negotiated service parameters for the subsequent call with the access terminal.

39. The computer program product of claim 35, wherein the set of negotiated service parameters comprise at least one of forward multiplex option, reverse multiplex option, forward channel radio configurations, reverse radio configurations, radio link protocol related parameters, or quality of service related parameters.

40. An apparatus for wireless communication, comprising:
at least one processor;
a communication interface coupled to the at least one processor; and
a memory coupled to the at least one processor,
wherein the at least one processor is configured to:
set up an initial call with an access terminal using a set of negotiated service parameters;
end the initial call; and
establish a subsequent call with the access terminal based on the set of negotiated service parameters received from the access terminal.

41. The apparatus of claim 40, wherein for establishing the subsequent call, the at least one processor is further configured to: receive a call origination message or a page response message from the access terminal, comprising information corresponding to the set of negotiated service parameters.

42. The apparatus of claim 41, wherein for establishing the subsequent call, the at least one processor is further configured to:
send a service connect message to the access terminal without performing service negotiation with the access terminal; and
receive a service connect completion message from the access terminal.

43. The apparatus of claim 40, wherein for establishing the subsequent call, the at least one processor is further configured to:
send a call confirmation message to the access terminal indicating acceptance of the set of negotiated service parameters for the subsequent call with the access terminal.

44. The apparatus of claim 40, wherein the set of negotiated service parameters comprise at least one of forward multiplex option, reverse multiplex option, forward channel radio configurations, reverse radio configurations, radio link protocol related parameters, or quality of service related parameters.
